(19) United States
(12) Patent Application Publication
(10) Pub. No.: US 2010/0236938 A1
(43) Pub. Date: Sep. 23, 2010

(54) FUEL ADDITIVE APPARATUS, SYSTEM AND METHOD

(76) Inventors: Lynell Braught, White Sulphur Springs, WV (US); John R. Lersch, Gallipolis, OH (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 12/407,797

(22) Filed: Mar. 20, 2009

(51) Int. Cl. C25B 1/04; F02B 43/08; C25B 9/00

(52) U.S. Cl. 205/628; 123/3; 204/272

(57) ABSTRACT

An apparatus for generating a fuel additive comprises a canister having an inlet and an outlet. An electrode may be concentrically aligned within the canister and project from the canister. A plurality of electrode plates may be included, the plates generally concentric to the electrode. A plurality of insulation layers may also be included, wherein each insulation layer may be disposed between the plates. The apparatus may also include a transparent column externally mounted to the canister. A ball may be disposed in the sleeve.

### BACKGROUND

This application discloses embodiments and claims generally related to an apparatus generating a fuel additive for a combustion engine. Certain embodiments of the invention pertain to an apparatus generating oxyhydrogen gas that is introduced into an engine.

Related technology may include fuel and water vaporized for internal combustion engines as represented in U.S. Pat. No. 4,594,991 (Harvey). Harvey describes a fuel mixture injection apparatus associated with the carburetor of an internal combustion engine designed to improve engine efficiency by delivering the mixture of vaporized gasoline, steam and air directly into the carburetor. The gasoline is vaporized and ducted. Simultaneously, water from a reservoir flows through a line in response to engine load and temperature conditions. The line passes through the closed chamber where the water is preheated. The line then leads to a heat exchanger connected to the engine's exhaust manifold where the water is converted to steam. From the heat exchanger, the steam is ducted either into the carburetor or directly into the intake manifold.

This application presents claims and embodiments that fulfill a need or needs not yet satisfied by the products and inventions previously or presently available, including the example of the art presented above. However, the art does not appear to disclose the combination of elements and features disclosed herein. The applicant is unaware of any product, disclosure or reference that discloses the features of the claims and embodiments disclosed herein, and as more fully described below.

### SUMMARY OF THE INVENTION

In one embodiment of the invention, an apparatus for generating a fuel additive is described, the apparatus comprising a canister having an inlet and an outlet. An electrode may be concentrically aligned within the canister and project from the canister. A plurality of electrode plates may be included, the plates generally concentric to the electrode. A plurality of insulation layers may also be included, wherein each insulation layer may be disposed between the plates. The apparatus may also include a transparent column externally mounted to the canister. A ball may be disposed in the sleeve.

In another embodiment of the invention, an apparatus for generating a fuel additive, is described, the apparatus comprising a canister having a floor and a top and a sidewall disposed between the floor and top, the floor, sidewall and top defining a volume therein. An inlet, an outlet and an opening may be disposed in the top. A sealant may be disposed along the floor of the canister. An electrode may be concentrically aligned within the canister and projecting from the canister, wherein the electrode may be suspended within the volume of the canister by the opening. A plurality of electrode plates may be aligned concentric to the electrode, adjacent plates separated by a distance approximately 0.125 inches. The sidewall of the canister forms an outermost plate. A plurality of insulation layers may be included, each insulation layer intermediately disposed between adjacent plates. A transparent column may be externally mounted to the canister, the sleeve having a ball disposed therein. An electricity source operatively coupled with the electrode. A ground may be operatively coupled to the exterior surface of the canister.

In another embodiment of the invention, an internal combustion engine with a fuel additive apparatus is described, the engine comprising a fuel burning cylinder having a cylinder head, the cylinder receiving a mixture of fuel and air, the air provided by an air intake. The apparatus comprises a canister having an inlet and an outlet, the outlet in fluid communication with the air intake. An electrode may be concentrically aligned within the canister and projecting from the canister. A plurality of electrode plates may be concentric to the electrode. A plurality of insulation layers may be included, each insulation layer disposed between the plates. The apparatus may also include a transparent column externally mounted to the canister, the sleeve having a ball disposed therein. The apparatus may be operatively coupled to a ground wire and an electrical wire, the electrical wire operatively coupled to the electrode.

In another embodiment of the invention, a method for making a fuel additive for a combustion engine is described, the method comprising the coupling a fuel additive apparatus with an electricity source and the air intake of the engine, and then filling the apparatus with distilled water and an electrolyte, the concentration of distilled water to electrolyte comprising approximately 100:1. Thereafter, the distilled water is converted into a gas comprising H₂ and O₂ and having a molar ratio of approximately 2:1. The generated gas is then transferred to the air intake of the engine.

The “Summary” is provided merely to introduce certain concepts. The “Summary” is not intended to identify any key or essential feature of the claimed subject matter.

### BRIEF DESCRIPTION OF THE DRAWINGS

FIG. 1 is a front or rear view of an apparatus utilized for generating a fuel additive;

FIG. 2 is a side view of FIG. 1;

FIG. 3 is cross-sectional view of FIG. 1 taken along line III-III; and

FIG. 4 is a schematic of an apparatus operatively coupled and installed in a combustion engine.

### DESCRIPTION OF THE EMBODIMENTS

A fuel additive apparatus, system and/or method is generally described and depicted herein, the apparatus, system and/or method integrated within a combustion system utilizing carbon and/or hydrocarbon fuel(s) generating energy harnessed for use. This application contemplates use of the apparatus, system and/or method as integral or retrofit to existing power plants, stationary engines or turbines, engines for conveyances or vehicles (e.g. automobiles, marine vessels, carts). Therefore, the examples provided herein are merely examples of possible applications, but other applications are contemplated.

A fuel additive apparatus is described and depicted, denoted by reference character 10. The fuel additive apparatus 10 may be operatively coupled with various components of an automobile to provide electrical current necessary for converting liquid material into a fuel additive material later consumed by the engine. The fuel additive apparatus 10 may also be operatively coupled with various components of a combustion engine to deliver the fuel additive material and mix with the combustible fuel material for consumption within a combustion chamber, yielding a better burning and more efficient fuel mixture for the engine.

Referring now to FIG. 1 through FIG. 4, the fuel additive apparatus (“apparatus”) 10 for generating a fuel additive material is depicted. The apparatus 10 may include a canister 12 having an inlet 14 and an outlet 16. A central electrode 18 may be concentrically aligned within the canister 12. A plurality of steel electrode plates 20 may be concentrically aligned relative to the electrode 18, forming a series of plates 20 of increasing or decreasing diameters (as viewed in cross-section depicted in FIG. 3), depending on the relative starting reference point. A plurality of insulation layers 22 may be concentrically aligned to the electrode 18, as well, with each layer 22 communicating with each plate 20. Each insulation layer 22 may be intermediately disposed between adjacent plates 20. Externally, a transparent column 24 is mounted to the canister 12, the column 24 in fluid communication with the internal region of the canister 12 via a plurality of ports 28 and 30, respectively. The column 24 may include a ball 26 disposed therein. During operation of the apparatus 10, the ball 26 may be suspended within the column 24 thereby serving as a liquid level indication to the user.

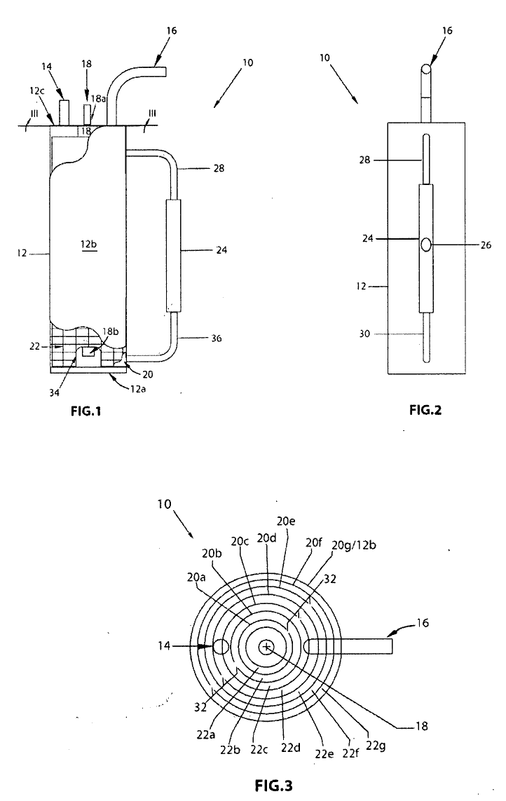

In one embodiment, the canister 12 generally comprises a cylindrical form, though other arrangements or configurations are contemplated. The dimensions of the canister 12 may vary as a function of the size of the power station, engine or turbine to which the apparatus 10 is operatively coupled. The canister 12 may have a height between four inches and twenty-four inches, and a diameter between three inches and twelve inches. Generally, the canister 12 may comprise a floor 12a, an upstanding sidewall 12b, and a top 12c. The floor 12a, sidewall 12b and top 12c cooperatively define an interior volume or space in which several components of the apparatus 10 are found and into which liquid is introduced and gas generated. The floor 12a may include a silicone or epoxy insulating sealant 34 that is disposed between the base of the electrode 18 (sealant not communicating with the electrode 18), the plates 20 and the insulation 22, respectively, to promote electrolysis of the liquid material introduced therein. The sidewall 12b may have one or more ports (depicted as two ports 28 and 30 in FIG. 1 and FIG. 2) depending from the exterior surface of the sidewall 12b and providing fluid communication between the interior volume or space and an external space (e.g. column 24, as more fully explained below). The top 12c may have a plurality of apertures formed therein to accommodate the inlet 14, the outlet 16 and an end of electrode 18 projecting therethrough. The top 12c suspends the electrode 18 within the canister 12, positioning the electrode 18 so that the base of the electrode 18 is approximately one-half inch from the floor 12c of the canister 12. Optionally, an insulator may be used in combination with top 12c to suspend the electrode 18, the insulator aiding in the suspension as well as preventing escape of the gas generator by the apparatus 10.

A liquid mixture of distilled water and electrolyte are added to the interior of the canister 12 through inlet 14. The electrolyte may be selected from a variety of commercially available electrolytic liquids, such as sodium hydroxide, potassium hydroxide, as well as magnesium sulfate, elemental cobalt in aqueous solution and/or elemental nickel in aqueous solution, or a mixture of one or more of the electrolytes identified. The inlet 14 may include a seal or cap, such as a push cap or screw cap. The outlet 16 provides fluid communication between the interior volume of the canister 12 and the air intake of an engine. The fuel additive material, generally in the form of a gas (e.g. H₂ and O₂ in a molar ratio of approximately 2:1), exits the outlet 16 and into the air intake where the gaseous fuel additive material mixes with carbon and/or hydrocarbon based fuels, including gasoline or diesel fuel, as well as natural gas, propane, methanol, ethanol, biodiesel, coal or other similar fuels.

The electrode 18 may be concentrically disposed within the canister 12, generally concentric about an imaginary central axis running along the axial length of the canister 12. The electrode 18 may be formed of a variety of materials, including a solid stainless steel bolt or stainless steel tubing, or other similarly conductive materials. The electrode 18 partially projects through the top 12c and provides a mount for the application of electricity from a source (e.g. automobile battery). The end of the electrode 18 projecting through the top 12c may be generally denoted as an electrode post, or post, 18a, opposite to the end 18b adjacent the floor 12a of canister 12.

Referring now to FIG. 3, a plurality of electrode plates 20 and a plurality of insulation layers 22 are disposed within the interior volume or space of canister 12. The plates 20 and layers 22 are concentric relative to the electrode 18. Referring to FIG. 3, a cross-sectional view of the canister 12 and components, and using the electrode 18 as a reference point, insulation layers 22a-22g are concentrically disposed about the electrode 18. Similarly, the plates 20a-20f are concentrically disposed about the electrode 18. The layers 22 and plates 20 are generally arranged so that a first insulation layer 22a surrounds electrode 18. A plate 20a is disposed between layers 22a and 22b; layer 22b is disposed between plates 20a and 20b; this arrangement repeats and terminates with the sidewall 12b (also denoted by reference character 20g) functioning as the outermost plate 20 in the series. Thus, the arrangement may be described (innermost to outermost) as: electrode 18; first insulation layer 22a; first plate 20a; second insulation layer 22b; second plate 20b; third insulation layer 22c; third plate 20c; fourth insulation layer 22d; fourth plate 20d; fifth insulation layer 22e; fifth plate 20e; sixth insulation layer 22f; sixth plate 20f; seventh insulation layer 22g; and seventh plate/sidewall 20g/12b.

Each plate comprises a stainless steel, or other similarly conductive material, body formed into a cylinder having open ends and disposed within the canister 12. It has been determined that the number of plates 20 is correlated to the voltage applied to the electrode 18, and the correlation is that a plate 20 is provided for every two volts (2V) of electricity applied. Therefore, and representing but one example of an embodiment, if a 14V current is applied to the electrode 18, the canister 12 may have seven plates 20a-20g arranged concentrically about the electrode 18 within canister 12. The plates 20a-20g/12b each have a thickness in the range between 0.003 inches and 0.010 inches, and generally within a range between 0.003 inches and 0.005 inches, and having some embodiments utilize a thickness of approximately 0.004 inches. The plates 20a-20g/12b are serially arranged and equidistantly spaced relative to one another, wherein the space between adjacent plates 20 is approximately 0.125 inches. In one embodiment, the plates 20 may comprises at least one textured surface integral to or applied to the plates 20 to provide an increase in surface area, thereby increasing efficient production of gas. In one embodiment, each plate 20a-20f within the canister 12 may have a hole 32 disposed therein, formed approximately one inch from the base of each plate 20a-20f. The hole 32 may be approximately 0.25 inches in diameter. Each hole 32 (on respective plates 20a-20f) is offset from holes on adjacent plates by approximately 180°. The holes 32 allow for equalization of the electrolytic liquid, preventing overheating of the liquid and apparatus 10, generally.

The plates 20 extend above the liquid level within the canister 12, but do not touch the top 12c of the canister 12. If the liquid level exceeds the height of the plates 20, the apparatus 10 overheats, which may cause operating inefficiencies and raising the potential for damage to the apparatus 10 or components of the apparatus 10. In one embodiment, the canister 12 may include liquid level indicia by which an operator may accurately fill the canister 12.

An insulation layer 22 is disposed between adjacent plates 20. Each layer 22 may be formed of a material that promotes separation of the liquid from the gas, allowing the gas material to effervesce and exit through outlet 16. Each layer 22 may have a thickness in a range between 0.100 inches and 0.200 inches, and some embodiment including a thickness of approximately 0.125 inches. Many materials may be suitable for this purpose. Representing only one example of an embodiment, woven polypropylene fabric has been found to be a suitable material, having a mesh-like appearance. Other materials that may be utilized include polyamides (e.g. nylon) and polyesters, among others. The woven nature of the polypropylene fabric enhances effervescence of the H₂/O₂ gas (molar ration ˜2:1) upward through the canister 12 and toward the outlet 16.

In one embodiment, as depicted in FIG. 1, the column 24 is disposed between ports 28 and 30, respectively. The column 24 comprises a cylindrical or tubular shape with open ends in fluid communication with the ports 28 and 30. A ball 26 may be disposed therein. In response to liquid entering through one or both of the ports 28 and/or 30, the ball 26 may be suspended within the column 24, such as by floating or resting on the surface of the electrolyte liquid entering the column 24. The ball 26 operates as a visual indication of the liquid level within the canister 12. The ball 26 may be fabricated from a variety of materials, including polymeric materials such as polypropylene. The liquid level will indicate when additional distilled water and/or electrolyte liquid may be needed or added to the canister 12 to replenish the exhausted contents. In one embodiment, the column 24 may include indicia by which the operator or user can determine if the liquid level needs replenishing.

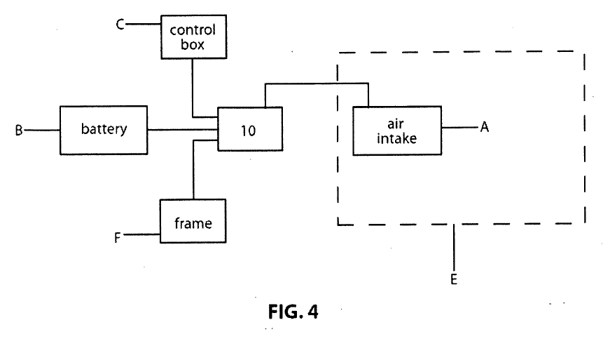

In one embodiment, and as depicted in FIG. 4, the apparatus 10 is operatively coupled with one or more sources of electricity and a combustion engine “E”. The source of electricity may be supplied by a variety of devices, such as a battery “B” of an automobile. Electrical wiring from the battery “B” may be electrically coupled to electrode 18 of the apparatus 10. A ground wire “G” may be operatively coupled to the exterior surface of the canister 12 and a grounding material (e.g. automobile frame “F”) to provide the electrical ground necessary in such an arrangement. The apparatus 10 may also be operatively coupled to a control box “C” in communication with a vacuum switch. When the automobile or conveyance is started, the electricity from the battery “B” is utilized to initiate operation of the vacuum switch of the control box “C”, energizing a relay that further energizes the electrode 18.

In one embodiment, a starting solution of approximately 500 mL of distilled water and approximately 25 mL of sodium hydroxide (or other electrolytic liquid) is added through the inlet 14 into the interior volume of canister 12. In climates that are colder than normal, the electrolyte concentration may be increased to lower the freezing point of the distilled water and prevent freezing of the apparatus 10, generally. Once the automobile is started, and the electricity from the battery “B” is flowing, the apparatus 10 converts the distilled water into H₂/O₂ gas. The electrolyte is not expended in an appreciable volume. The distilled water is expended at a rate of approximately 5 mL to 10 mL per trip (or approximately 5 mL to 10 mL per fifty miles). Thus, an automobile traveling approximately 4,000 miles will generally use less than one gallon of distilled water. Over the course of one year, and using available driving statistics, an average automobile will travel approximately 20,000 miles per year, and thus, will use approximately five gallons of distilled water in this period of time.

The outlet 16 is operatively coupled and in fluid communication with an air intake “A” of the engine “E”. The gaseous fuel additive (e.g. H₂/O₂; ˜2:1) exits through the outlet 16 and into the air intake “A” where the gaseous fuel additive mixes with the fuel (e.g. gasoline or diesel) and is then delivered to one or more combustion chambers within the engine “E”. The apparatus 10 generates approximately 0.5 L to 1.0 L of H₂/O₂ gas that may be delivered to the multiple combustion chambers provided in an automobile or other conveyance.

The gaseous fuel additive promotes more efficient burning of the fuel (e.g. gasoline or diesel), thereby increasing the miles per gallon (“MPG”) of an automobile utilizing the apparatus 10. Generally, it has been observed that fuel efficiency may increase between 10% and 50% or more. More specifically, it has been observed that fuel efficiency increases between 20% and 50%. It has also been observed that by effectively increasing the octane rating of fuel delivered to the combustion chamber, consumers may be able to purchase lower octane rated fuels at the pump. The higher octane rating eliminates the “pinging” that generally occurs when users provide non-recommended octane fuel(s) into the engine of the automobile. Therefore, the apparatus 10 generates cost savings by improving the fuel mileage of the automobile, reducing the purchase volume of the consumer, as well as permitting the user to purchase lower octane rate fuel at the pump, generally saving the consumer between ten and twenty-five cents per gallon of purchase. The impact on the battery “B”, for example, is minimal as the apparatus 10 draws approximately five (5) amps at twelve volts (12V) over the operational window.

It is to be understood that the embodiments and claims are not limited in its application to the details of construction and arrangement of the components set forth in the description and illustrated in the drawings. Rather, the description and the drawings provide examples of the embodiments envisioned, but the claims are not limited to the specific embodiments. The embodiments and claims disclosed herein are further capable of other embodiments and of being practiced and carried out in various ways, including various combinations and subcombinations that may not have been explicitly disclosed. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claimed appended hereto.

What is claimed is:

1. An apparatus for generating a fuel additive, the apparatus comprising:
a canister having an inlet and an outlet;
an electrode concentrically aligned within the canister and projecting from the canister;
a plurality of electrode plates concentric to the electrode;
a plurality of insulation layers, each insulation layer disposed between the plates; and
a transparent column externally mounted to the canister, the sleeve having a ball disposed therein.

2. The apparatus of claim 1, wherein adjacent plates are separated by distance of approximately 0.125 inches.

3. The apparatus of claim 1, wherein each plate comprises a thickness in the range of approximately 0.003 inches and 0.010 inches.

4. The apparatus of claim 1, wherein each plate comprises at least one textured surface.

5. The apparatus of claim 1, wherein each insulation layer comprises a woven polymeric material.

6. The apparatus of claim 1, wherein each insulation layer comprises a thickness of approximately 0.125 inches.

7. The apparatus of claim 1 further comprising a sealant disposed in the canister.

8. The apparatus of claim 7, wherein the sealant communicating with the lower margins of the plates and the insulation layers.

9. The apparatus of claim 7, wherein the sealant comprises an epoxy material.

10. The apparatus of claim 7, wherein the sealant comprises a silicone material.

11. An apparatus for generating a fuel additive, the apparatus comprising:
a canister having a floor and a top and a sidewall disposed between the floor and top, the floor, sidewall and top defining a volume therein;
an inlet, an outlet and an opening disposed in the top;
a sealant disposed along the floor of the canister;
an electrode concentrically aligned within the canister and projecting from within the canister, the electrode suspended within the volume of the canister by the opening;
a plurality of electrode plates concentric to the electrode, adjacent plates separated by a distance approximately 0.125 inches;
the sidewall forming an outermost plate;
a plurality of insulation layers, each insulation layer intermediately disposed between adjacent plates;
a transparent column externally mounted to the canister, the sleeve having a ball disposed therein;
an electricity source operatively coupled with the electrode; and
a ground operatively coupled to the exterior surface of the canister.

12. The apparatus of claim 11, wherein each plate comprises a thickness in the range of approximately 0.003 inches and 0.010 inches.

13. The apparatus of claim 11, wherein each plate comprises at least one textured surface.

14. The apparatus of claim 11, wherein each insulation layer comprises a woven polymeric material.

15. The apparatus of claim 14, wherein the material comprises polypropylene.

16. The apparatus of claim 11, wherein each insulation layer comprises a thickness of approximately 0.125 inches.

17. The apparatus of claim 11 further comprising a plurality of ports in fluid communication with the column.

18. An internal combustion engine with a fuel additive apparatus comprising:
a fuel burning cylinder having a cylinder head, the cylinder receiving a mixture of fuel and air, the air provided by an air intake;
the apparatus comprising:
a canister having an inlet and an outlet, the outlet in fluid communication with the air intake;
an electrode concentrically aligned within the canister and projecting from the canister;
a plurality of electrode plates concentric to the electrode;
a plurality of insulation layers, each insulation layer disposed between the plates; and,
a transparent column externally mounted to the canister, the sleeve having a ball disposed therein;
and,
the apparatus operatively coupled to a ground wire and an electrical wire, the electrical wire operatively coupled to the electrode.

19. The engine of claim 18 further comprising a liquid mixture of distilled water and electrolyte, the liquid mixture converted to a gaseous fuel additive.

20. The engine of claim 19, wherein the liquid mixture of distilled water and electrolyte has an initial concentration of approximately 100:1.

21. The engine of claim 18, wherein adjacent plates are separated by a distance of approximately 0.125 inches.

22. The engine of claims 18, wherein each plate comprises at least one textured surface.

23. A method for making a fuel additive for a combustion engine, the method comprising:
coupling a fuel additive apparatus with an electricity source and the air intake of the engine;
filling the apparatus with distilled water and an electrolyte, the concentration of distilled water to electrolyte comprising approximately 100:1;
converting the distilled water into a gas comprising H₂ and O₂ and having a molar ratio of approximately 2:1; and
transferring the gas to the air intake of the engine.
